(19) United States
(12) Patent Application Publication
(10) Pub. No.: US 2013/0219019 A1
(43) Pub. Date: Aug. 22, 2013

(54) Method and apparatus for disseminating and receiving information

(71) Applicant: Zach Haller, Chicago, IL (US)

(72) Inventor: Zach Haller, Chicago, IL (US)

(21) Appl. No.: 13/385,374

(22) Filed: Feb. 16, 2012

(51) Int. Cl. G06F 15/16; G06F 17/30

(52) U.S. Cl. 709/218

(57) ABSTRACT

The invention comprises a method of disseminating information from a business entity to a user whereby a central repository receives user contact information transmitted by a network device and whereby the contact information is associated with the user's portable communication device. The repository also sends selectable user-designated contact information to the business entity. The entity may use this contact information for marketing or other purposes. The central repository may also receive a transmission of information in response to a party finding the user's portable device if lost, and in response the repository may send a notification to the user informing that the user's device has been found.

### BACKGROUND

It is well-known that individuals often lose small, but important possessions, such as car keys or, more recently, electronic devices such as tablet PCs or mobile phones. In the past, losing one's cell phone was an annoyance, but not a traumatic event. Legacy cellular phones may have contained a telephone list and a few text messages, yet in many cases this information could conveniently be recovered. But with the new “smart phones,” which contain everything from an owner's personal pictures and music to a telephone list, loss of such a device is more serious. Losing a “smart phone” or a tablet PC now means losing a significant amount of personal information that is not easily recovered. Further, replacing these devices is expensive. To make matters worse, individuals often lose their smart phone in a public place where they cannot easily retrace their steps and find the device, such as an airport, a taxi, or a crowded restaurant. Thus, there is a need to provide a service and/or a product to reunite a lost device with its owner.

At the same time, many smart phone owners do not wish to incur any additional cost on top of expensive monthly data plan costs to pay for a specific service that may help in locating a lost smart phone. Thus, there is also a need whereby an owner can enjoy a service that would help recover a lost smart phone or other portable electronic device that stores important or sacred information.

Furthermore, business entities, in particular those that cater to consumers such as restaurants, bars, and night clubs, may desire to promote their business and to provide additional services to existing patrons. Marketing efforts of restaurants and bars often focus on emails, faxes, or phone calls to customers who provide their contact information to the business. The business establishment may then send special event or product notices to these patrons. Many customers, however, do not want simply to provide this information without receiving something in return. And buying assembled customer lists is expensive and often a gamble, because one does not know if these people are even interested in the business' offering. Businesses have finite marketing budgets and so are always interested in ways to expand marketing efforts at reasonable or lower costs.

Accordingly, there appears to be an unfilled need to provide a lost device communication mechanism or service that brings together business entities and patrons in a way beneficial to both parties.

### SUMMARY

Accordingly, an aspect of the present invention comprises a method of disseminating information from a business entity to a portable device user comprising a central repository receiving selectable, user-defined contact information conveyed via a network, with the contact information being associated with the user's portable device. The central repository sends the user's contact information over the network to a business entity. The central repository, in one embodiment, may also receive a transmission of lost device identification information in response to a party finding the user's portable device, and in response the repository may transmit a notification to the user and/or the business entity that the party's portable device has been found. This aspect of the invention may be implemented by a suitably-programmed data processing device, such as an Internet server, to implement routines to carry out the aforementioned steps. The server may embody a memory device to host the database; a communication interface to send and receive information over the Internet; a browser interface to effect conveyance of information with the business entity, the user, and the party finding a lost device; as well as other devices or routines to implement one or more of the aforementioned steps.

In another embodiment of the invention, the business entity may contact the user via the network and disseminate promotional information to the user. Such information may be related to special sales or the like. The contact information in various embodiments may comprise user-selected information, such as a user's name, email address, identification of the user's portable device, and/or an identification code that is associated with the business. In some embodiments of the invention, the network is the Internet.

The central repository may comprise one or more databases stored in a memory device of an Internet server containing the user's contact information or only certain aspects of the user's contact information. In some aspects of the invention, the central repository only transmits certain aspects of the user's contact information to the business. The transmissions may also be specially designed to operate on a portable electronic device.

The central repository may also comprise a communication interface that receives user contact information via the Internet, with the contact information being associated with a portable device of the user, and that receives a transmission in response to a party finding the user's portable device. The central repository may also comprise a transmitting apparatus that transmits the contact information of the user via the Internet to a business and that transmits a notification to a user relating to the transmission in response to a party finding the user's portable device. The central repository may also contain one or more databases that contain the user's contact information or only certain aspects of the user's contact information.

### BRIEF DESCRIPTION OF THE DRAWINGS

FIG. 1 illustrates an aspect of the invention describing the interaction between a user, a central repository, a business, and a party.

FIG. 2 illustrates a sample table containing user contact information in a central repository database.

FIG. 3 illustrates a flowchart of various embodiments of the invention that forms the basis of program instructions to implement steps of the invention.

### DESCRIPTION OF ILLUSTRATIVE EMBODIMENTS

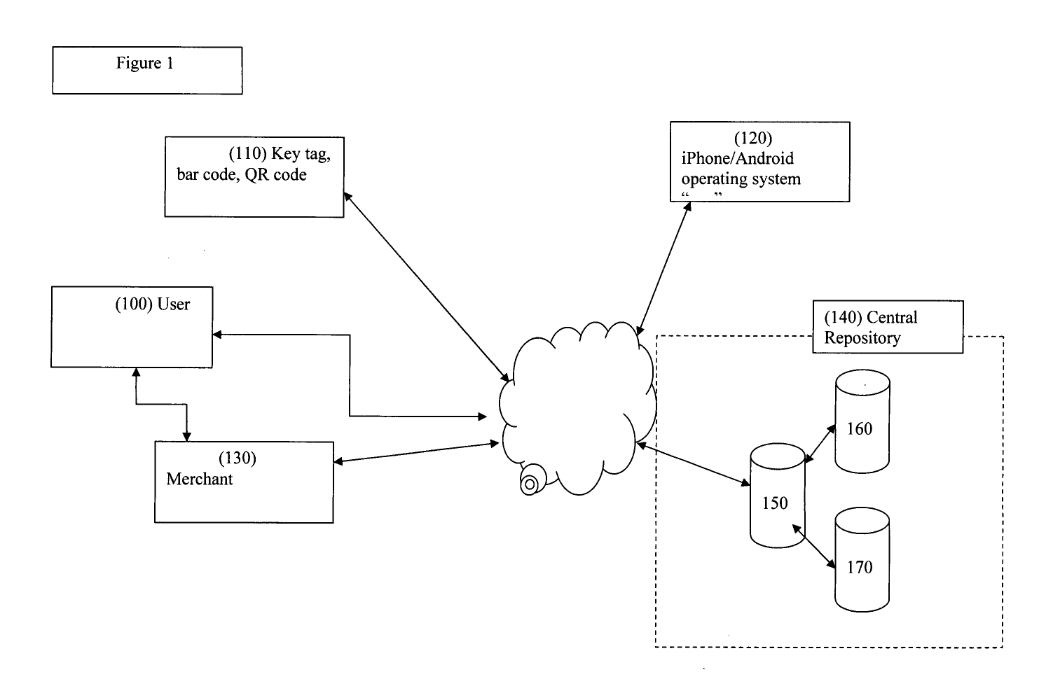

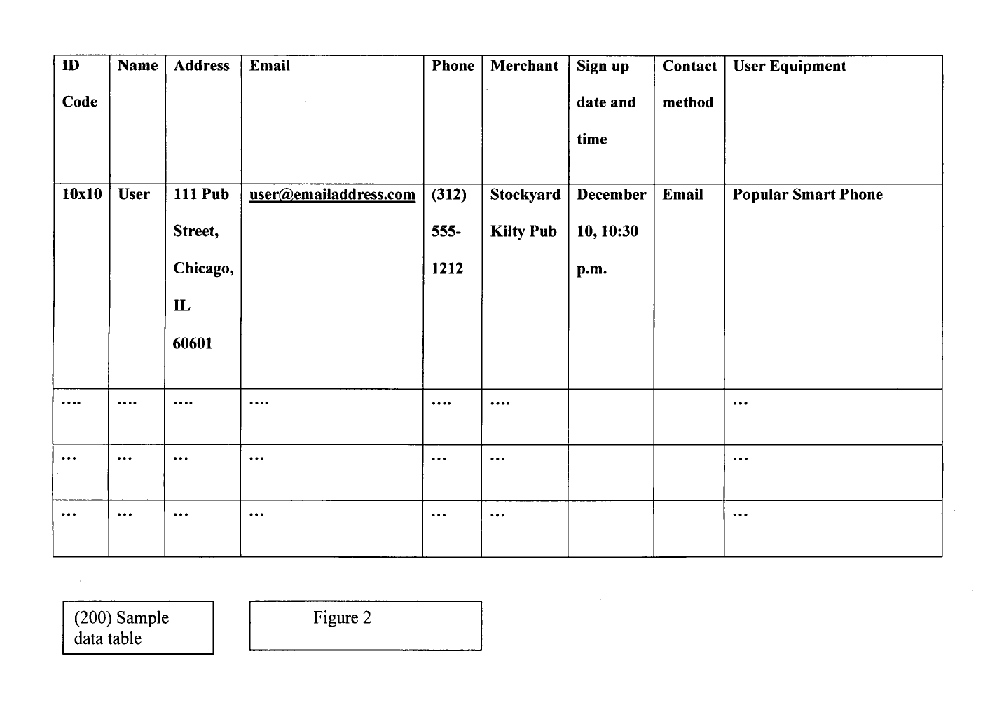

The following description illustrates various embodiments of the invention. Referring to FIG. 1, a user 100 may obtain a key tag, bar code sticker, or QR sticker 110 from a merchant 130 suitable for identifying a portable electronic device. The merchant 130 may provide this tag or sticker 110 free of charge at, for example, the merchant's place of business, online, or at an exhibition. The tag or sticker 110 contains a code or a similar indicator that may be used to register a device so that it may be tracked and located according to the invention. A user 100 then affixes this tag or sticker 110 to his or her portable device, such as a cellular phone (commonly and hereinafter called “smart phones”). The portable device contains vital information, such as email, a camera/video files, or other sensitive information Another embodiment of the invention allows a user 100 to download an application (or “app”) 120 to his or her smart phone that contains a code or other tracking information similar to the bar code or QR code 110. The app 120 may be downloaded from an online store or may be able to be scanned from a tangible medium to the user's 100 mobile device. The merchant 130 may likewise provide access to the app on its website, via an SMS text or email and may provide a tangible medium, such as a business card, from which a user 100 may scan and download the app 120. After the user 100 obtains a tag or sticker 110 or the app 120, the user 100 provides contact information to a central repository 140. The contact information may include the vital information described in FIG. 2, such as the user's name, address, email, and telephone number. As FIG. 2 shows, additional information may include the user's equipment, the date and time when the user provided the contact information, the preferred contact method and the merchant from whom the user obtained the code. In other embodiments, some or all of the information shown in FIG. 2 is automatically provided to the central repository 140, as is known in the art. For example, if the user 100 scans the information using their smart phone, the information in FIG. 2 can be automatically provided to the central repository 140. Additionally, upon receiving the ID Code, in one aspect of the invention, the merchant's name 130 and any merchant information is automatically provided to the central repository 140. Furthermore, the ID Code may be indicative of when the user 100 received the tag or sticker 110 or downloaded the app 120 to their mobile device.

In one aspect of the invention, the central repository 140 receives the user 100 contact information, ID code, merchant information, and the like at the server 150 and then stores this information in a database 160 or 170. The user information may be designated fully or limited by the user. The central repository 140 then provides the user 100 information to the merchant 130. In one aspect of the invention, the user 100 may opt to provide only certain aspects of his contact information to the central repository 140. For example, the user 100 may only want to provide her name and email information. Or, in another embodiment of the invention, the user 100 may provide all of the contact information to the central repository 140, but opt only to have some of the information provided to the merchant 130. In such an embodiment, the central repository 140 may separately store the information that it will provide to the merchant 130 on one database 160 and store the other information on a separate database 170. Other means of dividing this information using only one database are also known, such as through marking the records or creating access restrictions for the information that will not be provided to the merchant 130.

The merchant 130 may use the contact information for marketing purposes, such as for promotional advertisements, company updates, or the like. One of the reasons why the invention is so beneficial for a merchant is that the merchant 130 can contact the user 100 via a method which the merchant 130 is fairly certain will reach the user 100 and that will have low cost. For example, the merchant 130 may send a special coupon by email to the user 100. Since the merchant 130 knows that the user 100 has a smart phone and, in certain embodiments, may know the type of smart phone (e.g., iPhone or Android phone, as is known in the art), the merchant 130 can be fairly sure that the user 100 will receive the message. Furthermore, it costs next-to-nothing for the merchant 130 to send the coupon by email or SMS text or similar electronic means, and the merchant 130 can tailor the coupon to the particular mobile device. Furthermore, the merchant 130 may know when and how the user 100 obtained the code, and so can advantageously use that information to tailor the special or advertisement even further to the user 100.

If a user 100 should lose the portable electronic device, a person who finds the device (the “finder”) 180 may use the code information on the tag or contained in the app to contact the central repository 140 and to indicate that the finder 180 has found the user's 100 device. In at least one embodiment, the finder 190 may also leave a message for the user 100. The central repository 140 then references the code information against the user contact information contained in the one or more databases 160 or 170 to discern the user contact information. The central repository 140 then contacts the user 100 by one or more contact information means (such as email, fax, or telephone) to let him or her know that his or her device has been found and any further messages from the finder 190. An advantage to the invention is that the user 100 need not reveal his or her personal contact information to a finder 190, yet the user 100 can still have a lost device returned.

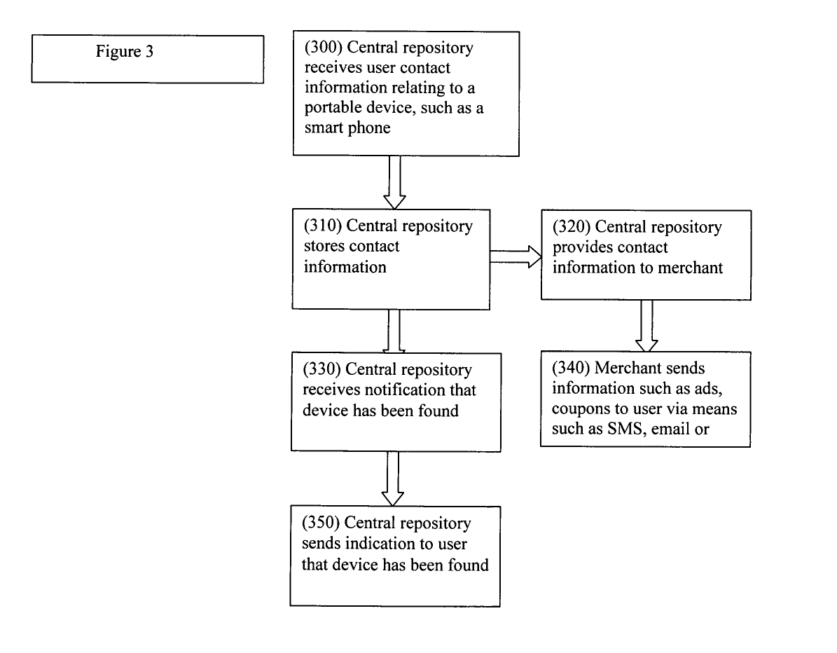

FIG. 3 illustrates one method of the invention. In 300, the central repository receives the user contact information that relates to the portable device, such as a smart phone. In 310, the central repository stores the contact information, which may include receiving the contact information at a server and then storing the contact information in one or more databases. In 320, the central repository provides contact information to a merchant, who may use this in marketing campaigns. Along with the contact information, the central repository may provide other useful information, such as when the user provided the contact information to the central repository and when the user obtained the code to contact the central repository. For example, the merchant may receive information that indicated the user obtained the code during one of the merchant's martini night specials, indicating that the user may enjoy martinis or special events at the merchant's establishment. In 340, the merchant sends marketing information such as an ad or coupon using the contact information.

In 330, the central repository may also receive a notification that the device has been found. For example, a finder may use the code on a sticker on the device or in an app on the device to contact the central repository. In 350, the central repository then compares the code received to its database records and determines which user corresponds to the code. In 360, the central repository then sends an indication to the user that the device has been found. The central repository may also send instructions to the finder of how to return the device to the user.

While the preferred embodiments of the invention have been shown and described herein, it will be understood that such embodiments are provided by way of example only. Numerous variations, changes, and substitutions will occur to those skilled in the art without departing from the spirit of the invention. Accordingly, it is intended that the appended claims cover all such variations that fall within the spirit and scope of the invention.

I claim:

1. A method of obtaining and disseminating information from a business entity to a user concerning a portable electronic device of said user, said method comprising:
a. A central repository receiving over a network user selectable, user-defined contact information of said user, said contact information being associated with a portable electronic device of said user; and
b. Said central repository transmitting said contact information of said user via said network to a business entity.

2. The method according to claim 1 further including said business entity contacting said user via said network and said business entity disseminating information about said business entity to said user.

3. The method according to claim 1 wherein said network is the Internet.

4. The method according to claim 1 wherein said contact information comprises said user's name, said user's email address, and an identification code.

5. The method according to claim 4 wherein said identification code is further associated with said business entity.

6. The method according to claim 4 wherein said contact information further comprises an identification of said portable device.

7. The method according to claim 1 wherein said central repository comprises a database containing said user contact information.

8. The method according to claim 7 wherein said central repository comprises a second database containing only certain aspects of said user contact information.

9. The method according to claim 8 wherein said central repository transmits to said business entity said only certain aspects of said user contact information.

10. A method of obtaining and disseminating information concerning a lost portable device of a user comprising:
a. A central repository receiving user contact information conveyed via a network, said contact information being associated with said lost portable device of said user;
b. Said central repository conveying said contact information of said user via said network to a business entity;
c. Said central repository receiving recovery information in response to a party finding said user's portable device; and
d. Said central repository transmitting a notification to said user relating to said recovery information in response to said party finding said user's portable device.

11. The method according to claim 10 wherein said business entity contacts said user via said network and said business entity disseminates information about said business entity to said user.

12. The method according to claim 10 wherein said network is the Internet.

13. The method according to claim 10 wherein said contact information comprises said user's name, said user's email address, and an identification code.

14. The method according to claim 13 wherein said identification code is further associated with said business entity.

15. The method according to claim 13 wherein said contact information further comprises an identification of said portable device.

16. The method according to claim 10 wherein said central repository comprises a database containing said user contact information.

17. The method according to claim 16 wherein said central repository comprises a second database containing only certain aspects of said user contact information.

18. The method according to claim 17 wherein said central repository transmits to said business entity said only certain aspects of said user contact information.

19. The method according to claim 10 wherein said user transmitting said contact information occurs through a program specially designed to operate on a portable electronic device.

20. A central repository for disseminating information concerning a lost portable device of a user, said repository comprising:
a. communication receiving interface for receiving user contact information via a network, said user contact information being associated with a portable device of said user, and for receiving a recovery information in response to a party finding said user's portable device;
b. a database for storing said user contact information; and
c. A communication transmitting interface for accessing said database and for transmitting said contact information of said user via said network to a business entity and for transmitting a notification to said user relating to said recovery information in response to said party finding said user's portable device.
